(19) United States
(12) Patent Application Publication
(10) Pub. No.: US 2026/0014809 A1
(43) Pub. Date: Jan. 15, 2026

(54) PRINTING DEVICE, CONTROL METHOD OF PRINTING DEVICE, AND STORAGE MEDIUM

(71) Applicant: CANON KABUSHIKI KAISHA, Tokyo (JP)

(72) Inventor: ASUKA WADA, Kanagawa (JP)

(21) Appl. No.: 19/261,749

(22) Filed: Jul. 7, 2025

(30) Foreign Application Priority Data
Jul. 10, 2024 (JP) 2024-110924

(51) Int. Cl. B41J 13/00; B41J 3/60; B41J 13/10; G03G 15/00; G03G 15/23; G06T 7/00

(52) U.S. Cl. CPC B41J 13/0036; B41J 3/60; B41J 13/106; G03G 15/231; G03G 15/5062; G03G 15/6552; G06T 7/001; G06T 2207/30144

(57) ABSTRACT

A print job management unit obtains a print job and print data and generates page management data based on the obtained print job and print data. The print job management unit also performs a printing process on arrival of a sheet at a printing unit, performs an image inspection process on arrival at an image inspection unit, and performs a conveyance destination switching process on arrival at a conveyance destination switching unit. In a case where an abnormal image is detected in the image inspection process, a reprinting process is performed and a sheet subsequent to a sheet including the page determined to be an abnormal image in the conveyance destination switching process and prior to a sheet including the reprinted page is conveyed to a double-sided printing conveying path for a stay. The reprinted sheet is thus discharged prior to the staying sheet.

### BACKGROUND

### Field of the Technology

The present disclosure relates to a technique for controlling a printing device which performs reprinting according to an inspection result of a print product.

### Description of the Related Art

In recent years, there has been proposed a technique for automating inspection work performed after print output to guarantee that a print product is free from defects and meets quality standards. Examples of the technique include a method of obtaining in advance read image data on a conforming print product to be a criterion and comparing the data with read image data on other print products, and a method of comparing print data such as a raster image with read image data on a print product.

Further, in the event of detection of a page determined to be an abnormal image through the inspection work, a technique for further automating reprinting, or recovery printing, of the page has also been proposed. In a case where this recovery printing is tried to be performed for print products which should be output in page order, at the time of detection of an abnormal image, there may be a page which has been printed or is undergoing a printing process following the print product detected being abnormal. In this situation, in a case where the print product detected being abnormal is discharged to a sheet discharge tray for stacking and the normal print products are discharged in printing order to the sheet discharge tray for stacking, the stacking order differs from the original printing order and the print products cannot be stacked in page order on the sheet discharge tray. Japanese Patent Application Laid-Open No. 2017-58564 suggests a method of outputting print products in correct page order to a sheet discharge tray by comprising a second conveying path to temporarily accommodate pages subsequent to a page determined to be an abnormal image and discharging a reprinted page prior to the subsequent pages.

However, the technique described in Japanese Patent Application Laid-Open No. 2017-58564 has an issue that it is necessary to add the conveying path to temporarily save the subsequent pages and this results in additional cost.

### SUMMARY

Embodiments of the present disclosure include a printing device with a conveying path for performing a printing process for both sides of a sheet, the printing device comprising: a printing unit configured to perform a printing process for the sheet according to a print job; an inspection unit configured to perform an inspection process for a printed sheet subjected to the printing process; and a conveyance unit configured to discharge a printed sheet not detected being abnormal in an inspection result by the inspection unit to a first discharge destination and discharge a printed sheet detected being abnormal in the inspection result to a second discharge destination different from the first discharge destination, wherein in a case where the printing unit performs a reprinting process for a printed sheet detected being abnormal in the inspection result during a printing process for a plurality of consecutive pages, the conveyance unit conveys, to the conveying path, a printed sheet not detected being abnormal which is subsequent to the printed sheet detected being abnormal and is prior to the printed sheet subjected to the reprinting process such that the printed sheet makes a stay in the conveying path, and discharges the printed sheet subjected to the reprinting process to the first discharge destination prior to the staying printed sheet.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing a configuration of the whole of a printing device in embodiments.

FIG. 2 is a block diagram showing a hardware configuration example of a controller in the printing device in the embodiments.

FIG. 3 is a block diagram showing a software configuration example of the controller.

FIG. 4 is a flowchart for illustrating a sheet discharge process accompanied by reprinting in a printing device according to a first embodiment.

FIG. 5 is an example of page management data relating to the first embodiment.

FIG. 6A is an example of the course of printing process/image inspection process/conveyance destination switching process relating to the first embodiment.

FIG. 6B is an example of the course of printing process/image inspection process/conveyance destination switching process relating to the first embodiment.

FIG. 6C is an example of the course of printing process/image inspection process/conveyance destination switching process relating to the first embodiment.

FIG. 6D is an example of the course of printing process/image inspection process/conveyance destination switching process relating to the first embodiment.

FIG. 6E is an example of the course of printing process/image inspection process/conveyance destination switching process relating to the first embodiment.

FIG. 7A is an example of the course of updating of the page management data relating to the first embodiment.

FIG. 7B is an example of the course of updating of the page management data relating to the first embodiment.

FIG. 7C is an example of the course of updating of the page management data relating to the first embodiment.

FIG. 7D is an example of the course of updating of the page management data relating to the first embodiment.

FIG. 7E is an example of the course of updating of the page management data relating to the first embodiment.

FIG. 7F is an example of the course of updating of the page management data relating to the first embodiment.

FIG. 7G is an example of the course of updating of the page management data relating to the first embodiment.

FIG. 8 is a flowchart for illustrating the printing process relating to the first embodiment.

FIG. 9 is a flowchart for illustrating the image inspection process relating to the first embodiment.

FIG. 10 is a flowchart for illustrating the conveyance destination switching process relating to the first embodiment.

FIG. 11A is an example of the course of printing process/image inspection process/conveyance destination switching process relating to a second embodiment.

FIG. 11B is an example of the course of printing process/image inspection process/conveyance destination switching process relating to the second embodiment.

FIG. 11C is an example of the course of printing process/image inspection process/conveyance destination switching process relating to the second embodiment.

FIG. 11D is an example of the course of printing process/image inspection process/conveyance destination switching process relating to the second embodiment.

FIG. 12A is an example of the course of updating of the page management data relating to the second embodiment.

FIG. 12B is an example of the course of updating of the page management data relating to the second embodiment.

FIG. 12C is an example of the course of updating of the page management data relating to the second embodiment.

FIG. 12D is an example of the course of updating of the page management data relating to the second embodiment.

FIG. 13 is a flowchart showing the process of performing the conveyance destination switching process relating to the second embodiment.

FIG. 14A is an example of the course of printing process/image inspection process/conveyance destination switching process relating to a third embodiment.

FIG. 14B is an example of the course of printing process/image inspection process/conveyance destination switching process relating to the third embodiment.

FIG. 14C is an example of the course of printing process/image inspection process/conveyance destination switching process relating to the third embodiment.

FIG. 14D is an example of the course of printing process/image inspection process/conveyance destination switching process relating to the third embodiment.

FIG. 14E is an example of the course of printing process/image inspection process/conveyance destination switching process relating to the third embodiment.

FIG. 14F is an example of the course of printing process/image inspection process/conveyance destination switching process relating to the third embodiment.

FIG. 15A is an example of the course of updating of the page management data relating to the third embodiment.

FIG. 15B is an example of the course of updating of the page management data relating to the third embodiment.

FIG. 15C is an example of the course of updating of the page management data relating to the third embodiment.

FIG. 15D is an example of the course of updating of the page management data relating to the third embodiment.

FIG. 15E is an example of the course of updating of the page management data relating to the third embodiment.

FIG. 15F is an example of the course of updating of the page management data relating to the third embodiment.

FIG. 16 is an example of the course of printing process/image inspection process/conveyance destination switching process relating to the third embodiment.

FIG. 17 is an example of the course of updating of the page management data relating to the third embodiment.

FIG. 18 is a flowchart for illustrating the image inspection process relating to the third embodiment.

FIG. 19 is a flowchart for illustrating the conveyance destination switching process relating to the third embodiment.

### DESCRIPTION OF THE EMBODIMENTS

Embodiments of the present disclosure will be described below with reference to the drawings. It should be noted that the following embodiments do not necessarily limit the present disclosure. It should also be noted that not all combinations of features described in the embodiments are necessarily essential to the technical solution of the present disclosure.

### First Embodiment

In the present embodiment, in a case where an abnormality is detected in a specific page during a printing process for a plurality of consecutive pages, printed pages and a page undergoing the printing process stay in a conveying path for double-sided printing to discharge a reprinted page to a specific discharge destination prior to the staying pages. This makes it possible to stack print products in correct page order on the specific discharge destination while replacing the page determined to be an abnormal image.

### Configuration of Printing System

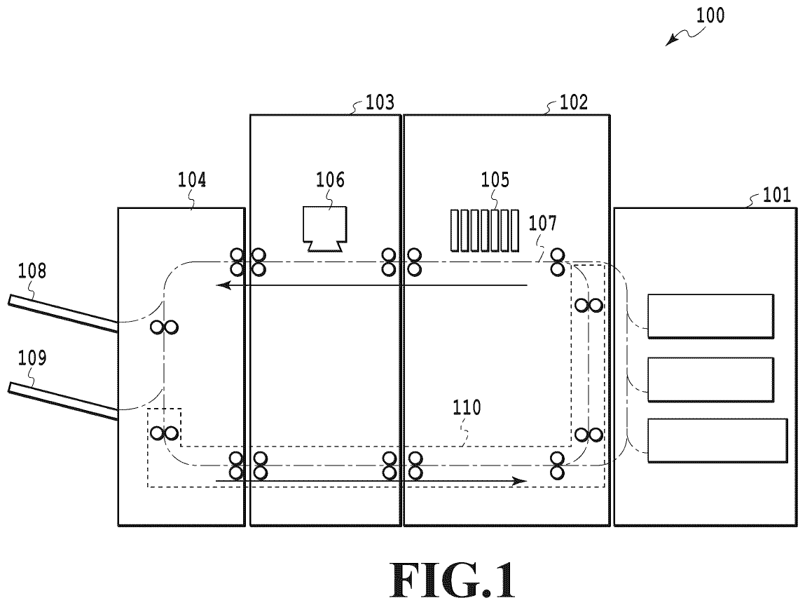

FIG. 1 is a configuration example of the whole of a printing device 100 to which the present disclosure is applied. A sheet feed unit 101 includes a plurality of sheet feed trays and each sheet feed tray is loaded with sheets by a user before the start of a printing process. After the start of a printing process, a sheet feed tray loaded with sheets designated in a print job is selected and a sheet fetched from the selected sheet feed tray is conveyed in a conveying path 107.

A printing unit 102 uses a printing module 105 to form an image on a sheet on the conveying path 107 and fix the image on the sheet based on the print job to be processed. Here, the image to be formed is not limited to meaningful information such as characters or graphics. Further, the printing module may be configured in such a manner as to eject ink directly to the sheet or transfer toner attached to a photosensitive member to the sheet, but the method or aspect of printing is not limited in the present embodiment.

An image inspection unit 103 uses an image capturing module 106 to read the surface of the sheet on the conveying path 107 and obtain it as electronic read image data. After that, based on the result of comparing the obtained read image data with read image data on a conforming print product, a raster image included in the print data or the like, it is determined whether the image formed on the sheet is a normal image or an abnormal image.

A conveyance destination switching unit 104 switches a conveyance destination of each sheet conveyed in the conveying path 107 to any one of a first sheet discharge tray 108, a second sheet discharge tray 109, and a double-sided printing conveying path 110. In the present embodiment, based on the inspection result of the image inspection unit 103, a sheet with a formed image determined to be a normal image is sent to the first sheet discharge tray 108 or the double-sided printing conveying path 110 and a sheet with a formed image determined to be an abnormal image is sent to the second sheet discharge tray 109.

The double-sided printing conveying path 110 inverts a sheet with one side printed and sends the sheet to the printing unit 102 again to enable a printing process for the back side. Here, in the present embodiment, in a case where an image of a specific page is determined to be an abnormal image, sheets which are subsequent to a sheet including the page determined to be an abnormal image and are prior to a sheet including a reprinted page are conveyed to the double-sided printing conveying path 110 such that the pages stay in the printing device. The reprinted page is then discharged to the sheet discharge tray 108 prior to the pages staying in the double-sided printing conveying path 110. After that, the pages staying in the double-sided printing conveying path 110 are discharged to the sheet discharge tray 108. In this manner, pages with formed images determined to be normal images can be stacked in correct page order on the sheet discharge tray 108.

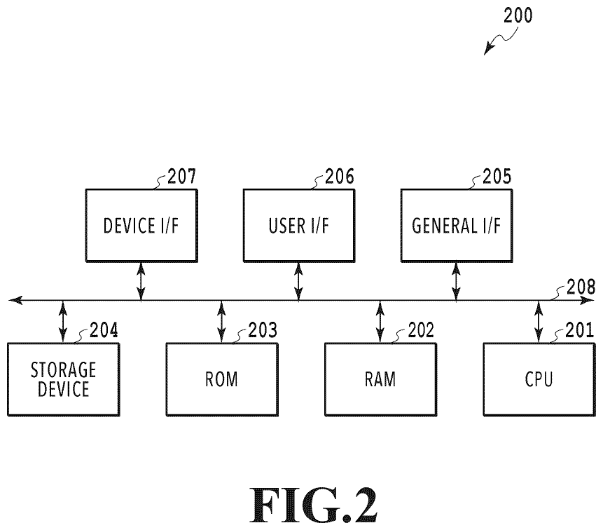

FIG. 2 is a hardware block diagram of a controller in the printing device 100. A controller 200 comprised in the printing device 100 has a CPU 201, a RAM 202, a ROM 203, a storage device 204, a general interface (I/F) 205, a user interface (I/F) 206, and a device interface (I/F) 207. The inside of the controller 200 is connected via a main bus 208. The CPU 201 is a processor which has control over each unit in the printing device. The RAM 202 serves as main memory, work area, or the like of the CPU 201. The ROM 203 stores a group of programs executed by the CPU 201. The storage device 204 stores applications executed by the CPU 201, job information and image data for use in printing, and the like. The general I/F 205 is a USB, LAN, or the like and can receive external input of data such as a print job and provide output of data from the printing device 100. The user I/F 206 informs a user of a current state or settings by displaying them on a touch panel liquid crystal display or the like and receives a printing restart instruction or the like from a user. The device I/F 207 requests each piece of hardware in the printing device 100 to perform processing and achieves synchronization between processing timings.

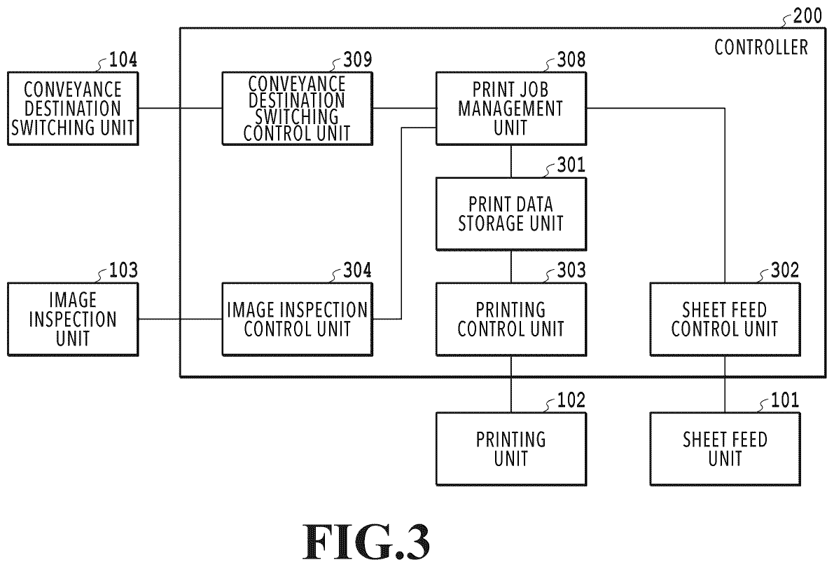

FIG. 3 is a block diagram showing a software configuration example of the controller 200 comprised in the printing device 100. The controller 200 has a print data storage unit 301, a sheet feed control unit 302, a printing control unit 303, an image inspection control unit 304, a print job management unit 308, and a conveyance destination switching control unit 309. The print data storage unit 301 generates page management data according to a print job input via the general I/F 205 or the user I/F 206 and updates and stores the page management data in line with the progress of a printing process. The page management data is management information to manage a conveyance destination of each page, including information about each page to be printed such as a printing state in each unit, order of arrival at each unit, and a file name of print data. The sheet feed control unit 302 causes the sheet feed unit 101 to feed a sheet designated by the print job into the conveying path 107.

The printing control unit 303 causes the printing unit 102 to perform a printing process based on print data stored in the print data storage unit 301. The image inspection control unit 304 causes the image inspection unit 103 to read the surface of the sheet on the conveying path 107 to obtain electronic read image data. The image inspection control unit 304 then compares the read image data with reference image data such as read image data on a conforming print product or a raster image included in the print data to thereby determine whether an image formed on the sheet is a normal image or an abnormal image.

The print job management unit 308 manages a processing state of each item of the page management data stored in the print data storage unit 301.

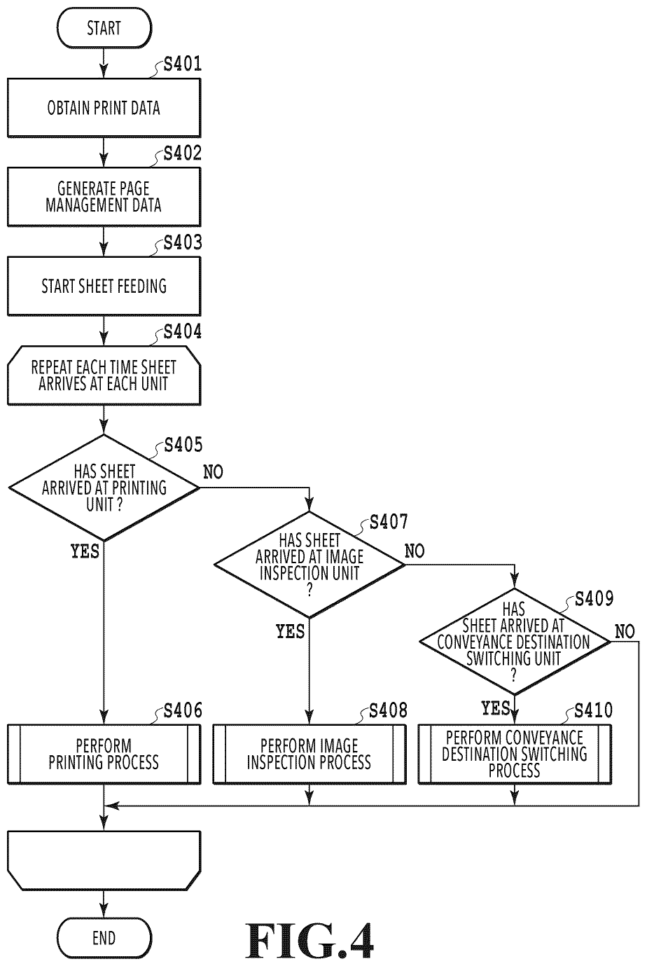

Based on the page management data stored in the print data storage unit 301, the conveyance destination switching control unit 309 selects any one of the first sheet discharge tray 108, the second sheet discharge tray 109, and the double-sided printing conveying path 110 as a conveyance destination of the sheet which has arrived at the conveyance destination switching unit 104. The method of selecting the conveyance destination based on the page management data will be described later in detail with reference to FIGS. 4 to 10.

### Process Executed by Printing Device (Overall)

FIG. 4 shows a flowchart for illustrating a sheet discharge process accompanied by a reprinting process in the printing device according to the first embodiment.

In S401, the print job management unit 308 obtains a print job and print data. The print data may be obtained from a printing server via a USB memory connected to the general I/F 205 or a LAN connected to the general I/F 205, but the measures or aspect of obtaining a print job and print data is not limited in the present embodiment.

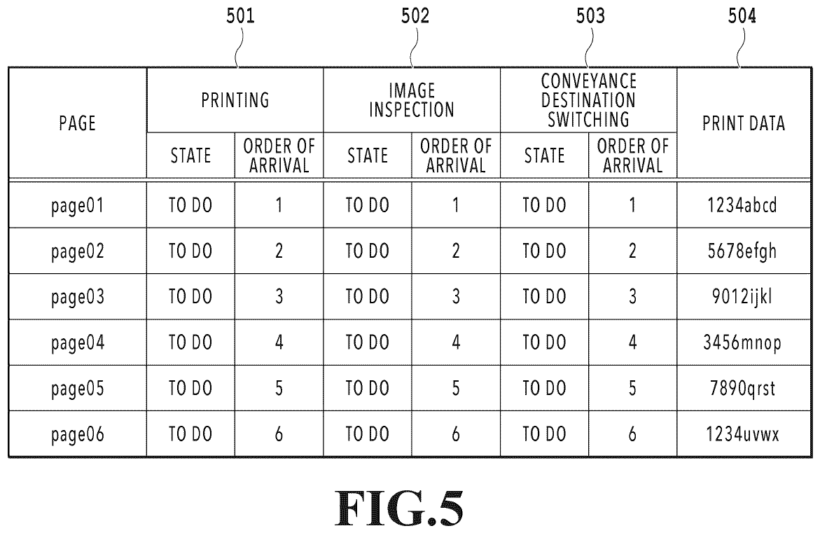

In S402, the print job management unit 308 generates page management data based on the obtained print job and print data. A specific example of the page management data will be described later with reference to FIG. 5.

In S403, the print job management unit 308 selects a sheet size or the like according to the page management data stored in the print data storage unit 301 and instructs the sheet feed control unit 302 to start sheet feeding.

In S404, the print job management unit 308 repeats the subsequent process up to S410 on each arrival of a sheet at each unit until printed sheets corresponding to all pages with formed images determined to be normal images are discharged to the first sheet discharge tray 108. The number of repeats varies according to the number of raster images in units of pages included in the print data obtained in S401 and the number of pages determined to be abnormal images through an image inspection process to be described later. The end of the repeat is equivalent to the end of the printing process for all items of print data, that is, the end of the print job obtained in S401.

In S405, the print job management unit 308 determines whether the sheet which had arrived in S404 has arrived at the printing unit 102. In a case where the sheet is determined to have arrived at the printing module 105, the process advances to S406. In a case where the sheet is determined to have arrived at a place other than the printing module 105, the process advances to S407.

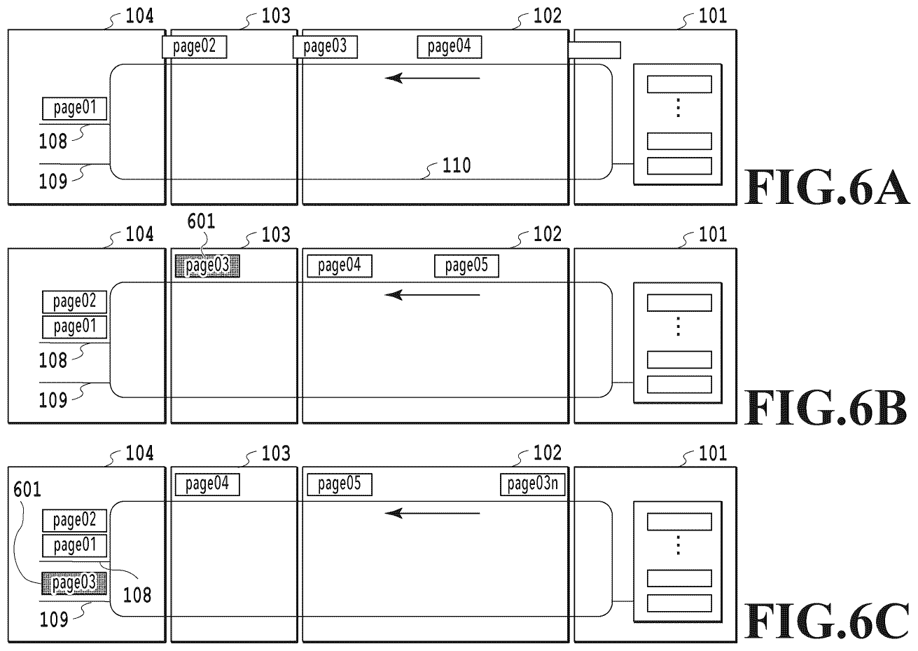

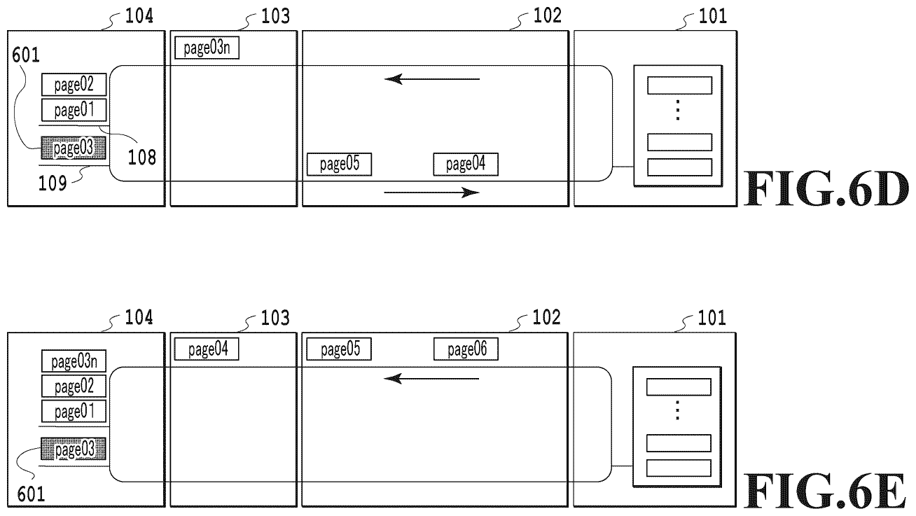

In S406, the print job management unit 308 causes the printing control unit 303 to perform a printing process for the sheet which had arrived in S404 while updating the page management data. This printing process will be described later in detail with reference to FIGS. 6A to 6E, 7A to 7G, and 8.

In S407, the print job management unit 308 determines whether the sheet which had arrived in S404 has arrived at the image inspection unit 103. In a case where the sheet is determined to have arrived at the image inspection unit 103, the process advances to S408. In a case where the sheet is determined to have arrived at a place other than the image inspection unit 103, the process advances to S409.

In S408, the print job management unit 308 causes the image inspection control unit 304 to perform an image inspection process for the sheet which had arrived in S404 while updating the page management data. This image inspection process will be described later in detail with reference to FIGS. 6A to 6E, 7A to 7G, and 9.

In S409, the print job management unit 308 determines whether the sheet which had arrived in S404 has arrived at the conveyance destination switching unit 104. In a case where the sheet is determined to have arrived at the conveyance destination switching unit 104, the process advances to S410. In a case where the sheet is determined to have arrived at a place other than the conveyance destination switching unit 104, the process returns to S404.

In S410, the print job management unit 308 causes the conveyance destination switching control unit 309 to perform a conveyance destination switching process for the sheet which had arrived in S404 while updating the page management data. This conveyance destination switching process will be described later in detail with reference to FIGS. 6A to 6E, 7A to 7G, and 10.

### Method of Holding Initial Values of Page Management Data

FIG. 5 shows an example of initial values of the page management data in the first embodiment. In the drawing, each row shows page information included in the print job and print data obtained in S401. The example shown in FIG. 5 is page management data on a print job to execute printing sequentially for six pages of page01 to page06. Columns 501 to 503 show “state” which indicates whether each page has been processed in the printing module 105, the image capturing module 106, and the conveyance destination switching unit 104, and “order of arrival” in which pages in “state” of being unprocessed will arrive at each unit. At the stage of S402 before the start of a print job, in each unit, “state” of all pages is set at “to do,” which represents an unprocessed state, and “1” to “6” are set in page order in “order of arrival.”

### Example of Output Control in the Case of Determining a Specific Page to be an Abnormal Image

FIGS. 6A to 6E are an example of the course of the printing process, the image inspection process, and the conveyance destination switching process in the first embodiment and show the course of conveyance/output of sheets in a case where a specific page is determined to be an abnormal image on the time series. In each drawing, a suffix number on “page” represents a page number. A page shaded as shown by 601 represents a page determined to be an abnormal image by the image inspection unit 103.

FIG. 6A shows that page01 has been discharged to the first (normal) sheet discharge tray 108, and page02 is being conveyed to the conveyance destination switching unit 104 after being determined to be a normal image in the image inspection unit 103. Page03 is being conveyed to the image inspection unit 103 after being subjected to a printing process in the printing unit 102 and page04 is being subjected to a printing process in the printing unit 102.

FIG. 6B shows that page02 has been discharged to the first sheet discharge tray 108 and page03 is being conveyed to the conveyance destination switching unit 104 after being determined to be an abnormal image in the image inspection unit 103. Page04 is being conveyed to the image inspection unit 103 and page05 is being subjected to a printing process in the printing unit 102.

FIG. 6C shows that page03 has been discharged to the second sheet discharge tray 109 and page04 is being conveyed to the conveyance destination switching unit 104 after being determined to be a normal image in the image inspection unit 103. Page05 is being conveyed to the image inspection unit 103. Immediately after that, for recovery printing of page03, page03n is fed to the printing unit 102 and subjected to a printing process to form the same image as page03.

FIG. 6D shows that page04 and page05 are being conveyed to the printing unit 102 through the double-sided printing conveying path 110 for a stay and page03n is being conveyed to the conveyance destination switching unit 104 after being determined to be a normal image in the image inspection unit 103.

FIG. 6E shows that page03n has been discharged to the first sheet discharge tray 108 and page04 is being conveyed from the sheet feed unit 101 to the conveyance destination switching unit 104 through the image inspection unit 103. Page05 is being conveyed from the sheet feed unit 101 to the image inspection unit 103 through the printing unit 102 and page06 is being subjected to a printing process in the printing unit 102. Since page04 and page05 have been determined to be normal images in the image inspection unit 103 before FIG. 6D, these pages pass through the printing unit 102 and the image inspection unit 103 without undergoing a printing process or an image inspection process here.

Through the above course of conveyance/discharge, even in a case where page03 is determined to be an abnormal image, all pages including page03n, which is a recovery print of page03, can be discharged in page order to the first sheet discharge tray 108.

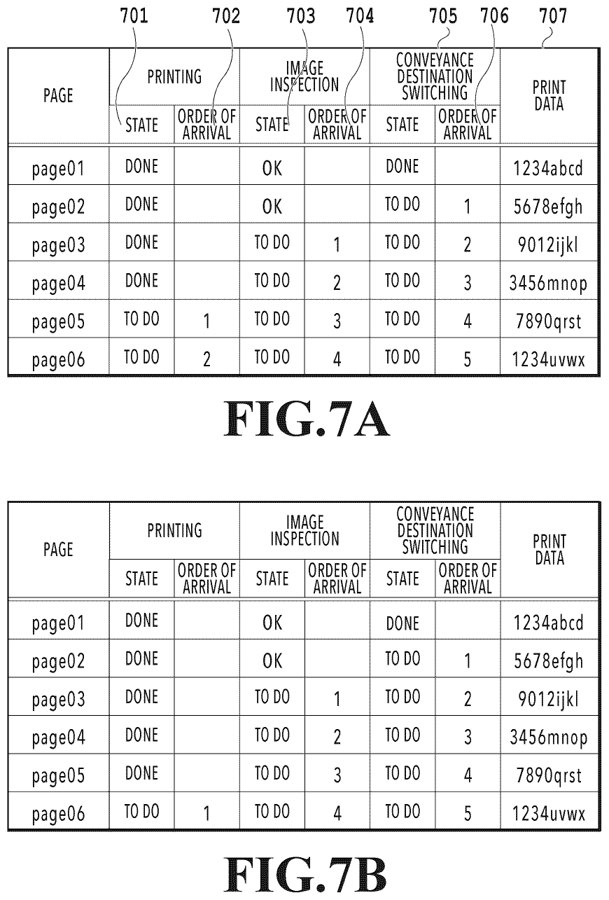

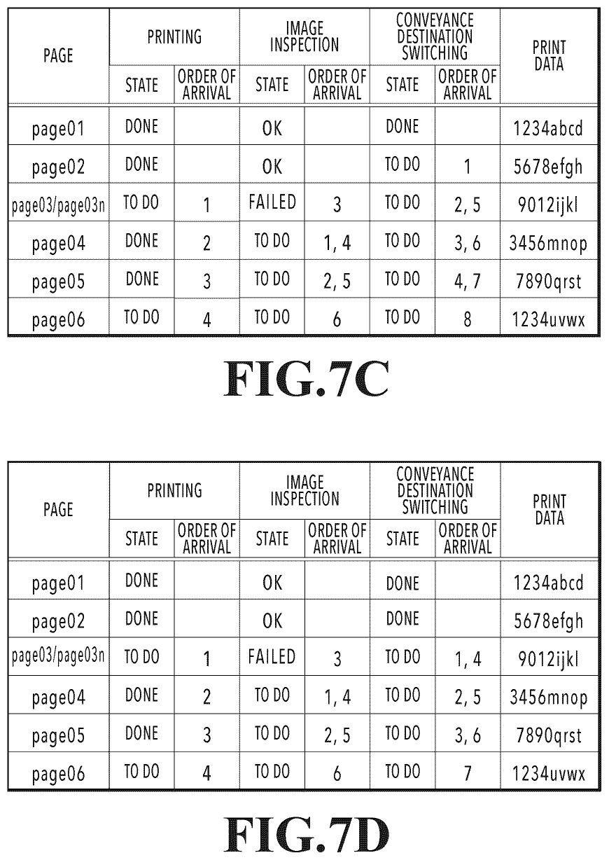

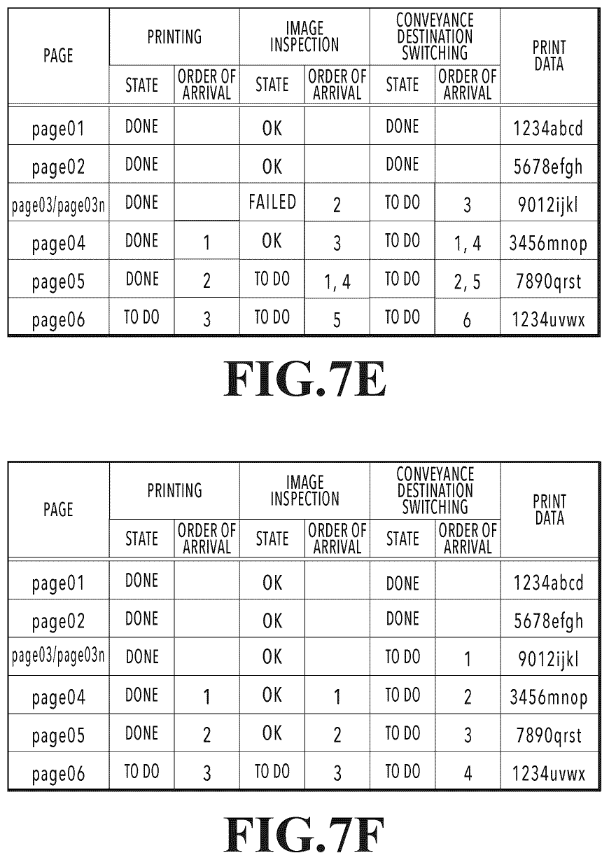

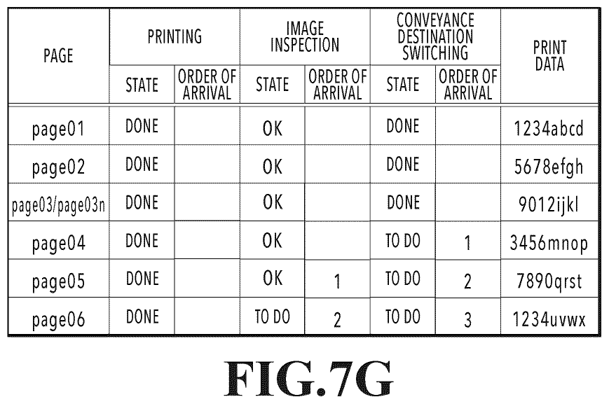

FIGS. 7A to 7G show an example of the course of updating of the page management data relating to the first embodiment. Column 701 shows a state of whether a printing process has been performed for each page by the printing unit 102; “done” is stored in a case where the process has been performed and “to do” is stored in a case where the process is yet to be performed. Column 702 shows “order of arrival” in which each page will arrive at the printing unit 102. Here, a page with a blank in column 702 indicates that the page is not scheduled to arrive at the printing unit 102 in the future. Column 703 shows a state of whether an image inspection process has been performed for each page by the image inspection unit 103; “OK” is stored in a case where the page is determined to be a normal image as a result of performing the process, “failed” is stored in a case where the page is determined to be an abnormal image as a result of performing the process, and “to do” is stored in a case where the process is yet to be performed. Column 704 shows “order of arrival” in which each page will arrive at the image inspection unit 103. A page with two numbers in column 704 indicates that the page will pass the image inspection unit 103 twice in the future. Further, a page with a blank in column 704 indicates that the page is not scheduled to arrive at the image inspection unit 103 in the future. Column 705 shows “state” indicating whether a conveyance destination switching process has been performed for each page in the conveyance destination switching unit 104 and column 706 indicates “order of arrival” in which each page will arrive at the conveyance destination switching unit 104. Column 707 shows a file name of print data to be printed on each page by the printing unit 102.

FIGS. 7A to 7G show the course of updating the page management data in a case where a specific page is determined to be an abnormal image on the time series and correspond to the states of conveyance/output shown in FIGS. 6A to 6E. FIGS. 7B to 7D show further details of the course of updating the page management data resulting in the state of conveyance/output shown in FIG. 6B on the time series.

The page management data shown in FIG. 7A indicates that the printing unit 102 has performed a printing process for page01 to page04, the image inspection unit 103 has determined that page01 and page02 are normal images, and the conveyance destination switching unit 104 has conveyed page01.

The page management data shown in FIG. 7B indicates that the printing unit 102 has performed a printing process for page05 and only page06 is yet to undergo a printing process.

The page management data shown in FIG. 7C indicates that the image inspection unit 103 has determined that page03 is an abnormal image and assigned “failed” to the image inspection state 703 of page03. As a result, in order to perform recovery printing based on the same print data as page03, a page for which recovery printing is performed is defined as “page03n” and “page03” is changed to “page03/page03n” in the page column of the page management data. The settings of page03/page03n are changed such that the printing state 701 is “to do” and the order of arrival 702 at the printing unit 102 is “1.” Further, in line with the recovery printing for page03n, the numbers subsequent to “1” are reassigned to page04 to page06, which are subsequent to page03/page03n, in the order of arrival 702 at the printing unit 102. Further, the order of arrival 704 of each page at the image inspection unit 103 is reassigned. More specifically, in the order of arrival 704 at the image inspection unit 103, “1” and the subsequent numbers are allocated to pages which are subsequent to page03 determined to be an abnormal image and are already “done” in the printing state 701 (page04 and page05 in FIG. 7C). Next, the subsequent numbers are allocated to page03/page03n and the subsequent pages. Here, two numbers are allocated to each of page04 and page05, which means that each of page04 and page05 will arrive at the image inspection unit 103 twice in the future. Further, the order of arrival 706 of each page at the conveyance destination switching unit 104 is reassigned. More specifically, “1” and the subsequent numbers are allocated to pages which are already “done” in the printing state 701 but are “to do” in the conveyance destination switching state 705 at the conveyance destination switching unit 104 (page02 to page05 in FIG. 7C). Further, the subsequent numbers are allocated to page03/page03n and the subsequent pages. Here, two numbers are allocated to each of page03 to page 05, which means that each of page03 to page 05 will arrive at the conveyance destination switching unit 104 twice in the future.

In FIG. 7D, page02 has been discharged to the first sheet discharge tray 108 by the conveyance destination switching unit 104, with the result that page02 has “done” in the conveyance destination switching state 705 and a blank in the order of arrival 706. Further, the order of arrival 706 of page03 and the subsequent pages at the conveyance destination switching unit 104 is decremented.

In FIG. 7E, page03n has been processed by the printing unit 102, with the result that page03/page03n has “done” in the printing state 701 and a blank in the order of arrival, and the order of arrival 702 of page04 and the subsequent pages is decremented. Further, the image inspection unit 103 has newly determined that page04 is a normal image, with the result that “OK” is assigned to the image inspection state 703 of page04 and the order of arrival 704 of each page is decremented. Further, a conveyance destination switching process is executed for page03 by the conveyance destination switching unit 104. More specifically, since the image inspection state 703 of page03/page03n is “failed,” page03 is discharged to the second sheet discharge tray 109 and the order of arrival 706 of each page at the conveyance destination switching unit 104 is decremented.

In FIG. 7F, the first conveyance destination switching process is performed for page04 and page05 by the conveyance destination switching unit 104. Here, since two numbers are assigned to each of page04 and page05 in the order of arrival 706 at the conveyance destination switching unit 104, the first conveyance destination is the double-sided printing conveying path 110 for a stay. In a case where a plurality of numbers are assigned to a page in the order of arrival at the conveyance destination switching unit 104 and the page arrives at the conveyance destination switching unit 104 multiple times, the conveyance destination is always the double-sided printing conveying path 110 except at the last arrival.

In FIG. 7G, page06 has been processed by the printing unit 102 and page04 has arrived at the image inspection unit 103. Since the image inspection state 703 of page04 is already “OK,” page04 skips the process in the image inspection unit 103 and is conveyed to the conveyance destination switching unit 104. Further, page03n is subjected to a conveyance destination switching process by the conveyance destination switching unit 104. Since the image inspection state 703 of page03n is already “OK,” page03n is discharged to the first sheet discharge tray 108.

Through the above course of updating of the page management data, even in a case where page03 is determined to be an abnormal image, all pages including page03n, which is a recovery print of page03, can be discharged in page order to the first sheet discharge tray 108.

### Details of Printing Process in S406

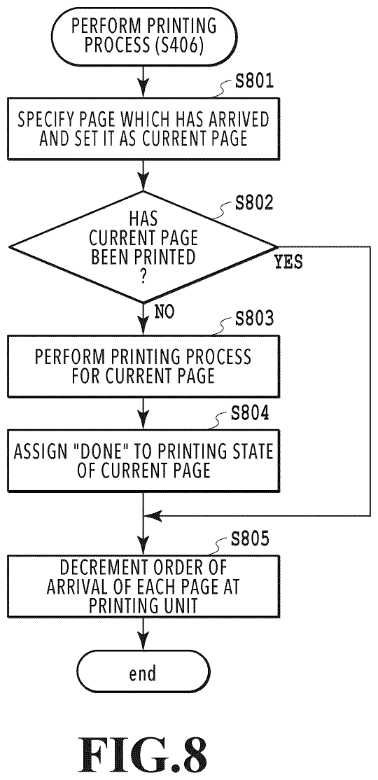

FIG. 8 shows a flowchart for illustrating the printing process according to the first embodiment. This printing process corresponds to S406 shown in FIG. 4. The description will be added below in line with this flowchart.

In S801, the printing control unit 303 specifies a page which has arrived at the printing unit 102 and sets the page as a current page. The page which has arrived at the printing unit 102 is specified by searching the page management data for a page which should arrive at the printing unit 102 next, that is, a page whose order of arrival 702 at the printing unit 102 is “1.”

In S802, the printing control unit 303 determines whether a printing process has been performed for the current page (whether the printing state 701 is “done”). In a case where the printing process is determined to have been performed, the process advances to S805. In a case where the printing process is determined to have not been performed yet, the process advances to S803.

In S803, the printing control unit 303 performs a printing process for the current page with the printing unit 102.

In S804, the print job management unit 308 updates the printing state 701 of the current page to “done” in the page management data stored in the print data storage unit 301.

In S805, the print job management unit 308 decrements the order of arrival 702 of each page at the printing unit 102 in the page management data stored in the print data storage unit 301.

Through the above printing process, in a case where a sheet which is subsequent to a sheet including a page determined to be an abnormal image and is prior to a sheet including a reprinted page is conveyed again to the printing unit 102 from the double-sided printing conveying path 110 for a stay, the printing process is skipped and only the conveyance is performed.

### Details of Image Inspection Process in S408

FIG. 9 shows a flowchart for illustrating the image inspection process according to the first embodiment. This image inspection process corresponds to S408 shown in FIG. 4. The description will be added below in line with this flowchart.

In S901, the print job management unit 308 specifies a page which has arrived at the image inspection unit 103 and sets the page as a current page. The page which has arrived at the image inspection unit 103 is specified by searching the page management data for a page which should arrive at the image inspection unit 103 next, that is, a page whose order of arrival 704 at the image inspection unit 103 is “1.”

In S902, the print job management unit 308 determines whether the current page has been determined to be a normal image by the image inspection unit 103 (whether the image inspection state 703 is “OK”). In a case where the current page has been determined to be a normal image, the process advances to S906. In a case where the current page has not been determined to be a normal image, that is, in a case where the image inspection state 703 is “failed” or “to do” in the page management data, the process advances to S903.

In S903, the print job management unit 308 causes the image inspection control unit 304 to perform an image inspection process for the current page.

In S904, the image inspection control unit 304 determines whether the current page has been determined to be a normal image in the image inspection process of S903 and transmits the determination result to the print job management unit 308. In a case where the current page is determined to be a normal image, the process advances to S905. In a case where the current page is determined to be an abnormal image, the process advances to S907.

In S905, based on the determination result received from the image inspection control unit 304, the print job management unit 308 updates the image inspection state 703 of the current page to “OK” in the page management data stored in the print data storage unit 301.

In S906, the print job management unit 308 decrements the order of arrival 704 of each page at the image inspection unit 103 in the page management data.

In S907, the print job management unit 308 updates the image inspection state 703 of the current page to “failed” in the page management data.

In S908, the print job management unit 308 returns the printing state 701 of the current page to “to do” in the page management data. Accordingly, in the next printing process, the printing unit 102 performs a reprinting process for the page determined to be an abnormal image in S904 and recovery printing is realized.

In S909, the print job management unit 308 reassigns the order of arrival 702 of the current page and the subsequent pages at the printing unit 102 in the page management data. In this reassignment, the numbers are allocated to the respective pages sequentially from the current page as shown in FIG. 7C.

In S910, the print job management unit 308 reassigns the order of arrival 704 of the current page and the subsequent pages at the image inspection unit 103 in the page management data. In this reassignment, the numbers are first allocated to pages which are subsequent to the page determined to be an abnormal image and are prior to the reprinted page, and the subsequent numbers are then allocated to the respective pages sequentially from the current page. As a result, as shown in FIG. 7C, two numbers are allocated to each of the pages which are subsequent to the page determined to be an abnormal image and are prior to the reprinted page.

In S911, the print job management unit 308 reassigns the order of arrival 706 of the current page and the subsequent pages at the conveyance destination switching unit 104. In this reassignment, the number corresponding to the reprinting is first allocated to the current page. Next, the numbers are allocated to pages which are subsequent to the page determined to be an abnormal image and are prior to the reprinted page, and the subsequent numbers are then allocated to the respective pages sequentially from the reprinted page. As a result, as shown in FIG. 7C, two numbers are allocated to each of the current page and the pages which are subsequent to the page determined to be an abnormal image and are prior to the reprinted page.

### Details of Conveyance Destination Switching Process in S410

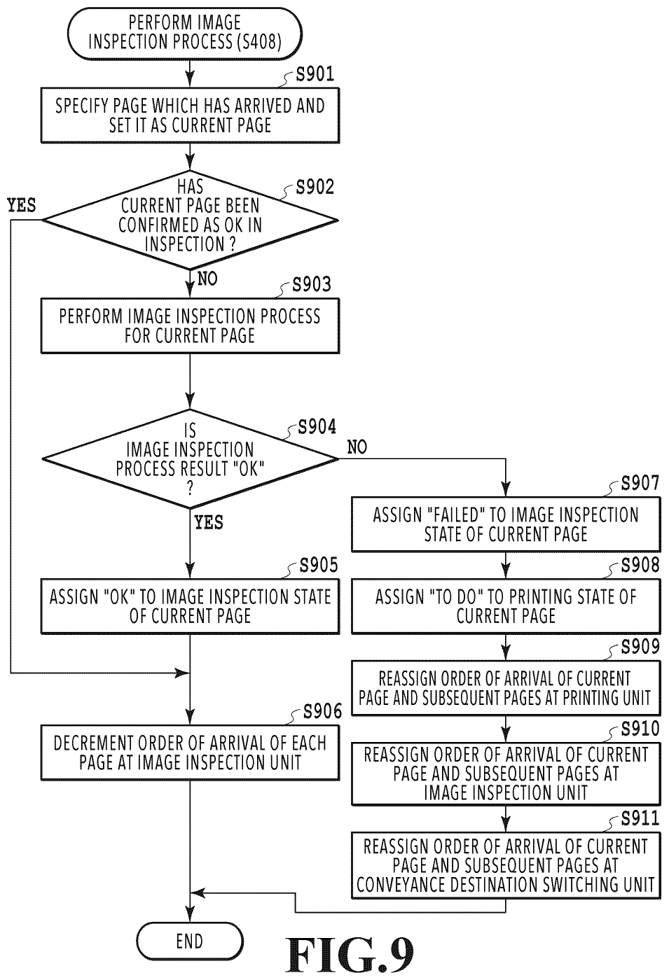

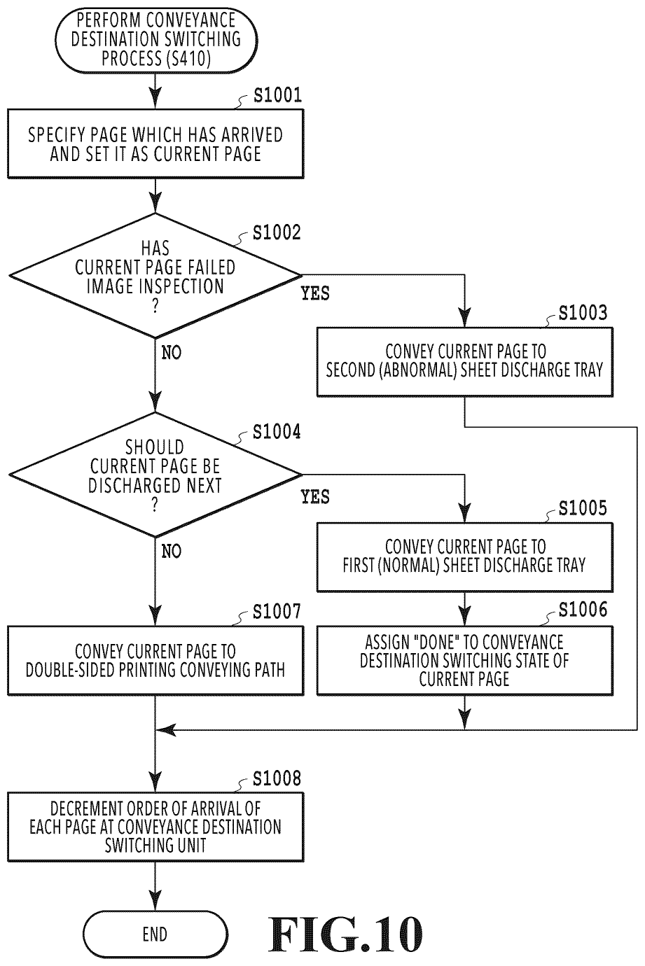

FIG. 10 shows a flowchart for illustrating the conveyance destination switching process according to the first embodiment. This conveyance destination switching process corresponds to S410 shown in FIG. 4. The description will be added below in line with this flowchart.

In S1001, the print job management unit 308 specifies a page which has arrived at the conveyance destination switching unit 104 and sets the page as a current page. The page which has arrived at the conveyance destination switching unit 104 is specified by searching the page management data for a page which should arrive at the conveyance destination switching unit 104 next, that is, a page whose order of arrival 706 at the conveyance destination switching unit 104 is “1.”

In S1002, the print job management unit 308 determines whether the image inspection state 703 of the current page is “failed” in the page management data. In a case where the image inspection state is determined to be “failed,” the process advances to S1003. In the other case, that is, in a case where the image inspection state is determined to be “OK,” the process advances to S1004.

In S1003, the print job management unit 308 causes the conveyance destination switching control unit 309 to discharge the current page to the second sheet discharge tray 109 with the conveyance destination switching unit 104 and the process advances to S1008.

In S1004, the print job management unit 308 determines whether the current page is a page to be discharged next. This is determined according to whether only “1” is assigned to the order of arrival 706 of the page which has arrived at the conveyance destination switching unit 104. For example, in a case where page04 arrives at the conveyance destination switching unit 104 in the page management data shown in FIG. 7E, since “1” and “4” are assigned to the order of arrival 706, the current page is determined not to be a page to be discharged next. In contrast, in a case where page03/page03n arrives at the conveyance destination switching unit 104 in the page management data shown in FIG. 7F, since “1” is assigned to the order of arrival 706, the current page is determined to be a page to be discharged next. In a case where the current page is determined to be a page to be discharged next, the process advances to S1005. In a case where the current page is determined not to be a page to be discharged next, the process advances to S1007.

In S1005, the print job management unit 308 causes the conveyance destination switching control unit 309 to discharge the current page to the first sheet discharge tray 108.

In S1006, the print job management unit 308 updates the conveyance destination switching state 705 of the current page to “done.”

In S1007, the print job management unit 308 causes the conveyance destination switching control unit 309 to convey the current page to the double-sided printing conveying path 110 without performing an inversion process.

In S1008, the print job management unit 308 decrements the order of arrival 706 of each page at the conveyance destination switching unit 104.

As described above, in the present embodiment, even in a case where a specific page of consecutive pages is determined to be an abnormal image, all pages including a page which is a recovery print of the page determined to be an abnormal image can be discharged in page order using the existing double-sided printing conveying path. Incidentally, the present embodiment is also applicable to a case where a plurality of consecutive pages are determined to be abnormal images. In a case where a certain number or more of pages are consecutively determined to be abnormal images, the printing process may be stopped and a prompt may be made to perform maintenance of the printing device or the like.

### Second Embodiment

### Measures for Printing the Same Content Consecutively on Pages

The second embodiment of the present disclosure will be described below mainly focusing on differences from the first embodiment. It should be noted that the technical scope of the present disclosure is not limited to this embodiment.

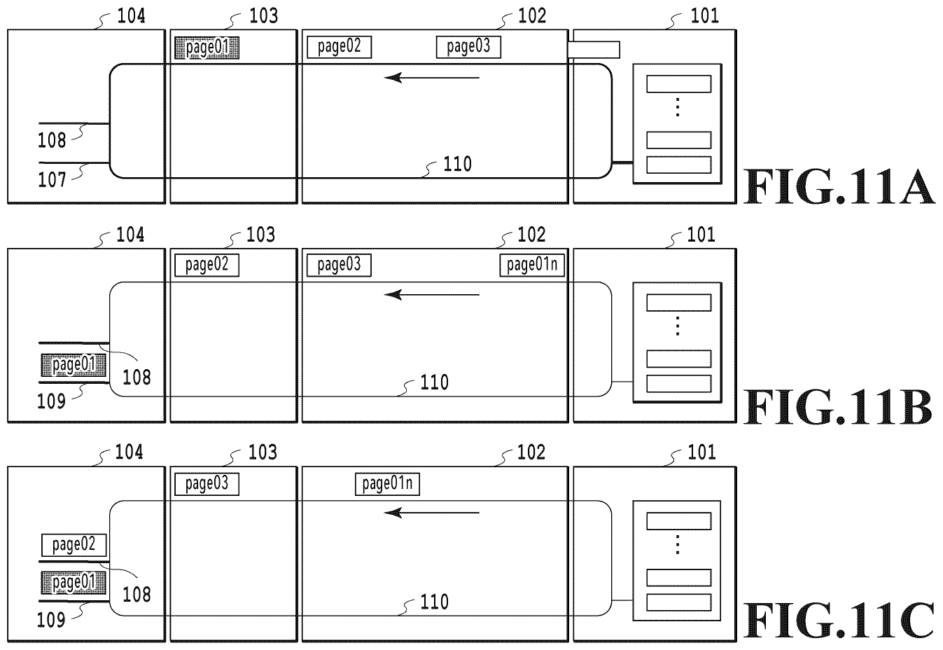

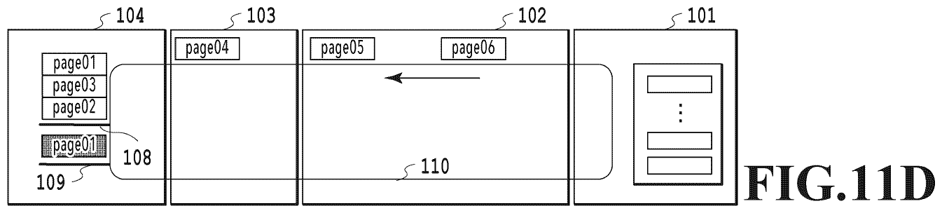

FIGS. 11A to 11D are an example showing the course of printing process/image inspection process/conveyance destination switching process in group printing to form an image of the same content consecutively on a plurality of pages according to the second embodiment and show the course of conveyance/output of sheets in a case where a specific page is determined to be an abnormal image on the time series. In each drawing, a suffix number on “page” represents a page number. Further, a page colored with a background color (gray) indicates a page determined to be an abnormal image by the image inspection control unit 304.

FIG. 11A shows that page01 is being conveyed to the conveyance destination switching unit 104 after being determined to be an abnormal image by the image inspection unit 103. Page02 is being conveyed to the image inspection unit 103 after being subjected to a printing process by the printing unit 102 and page03 is being subjected to a printing process by the printing unit 102.

FIG. 11B shows that page01 has been discharged to the second sheet discharge tray 109 and page02 is being conveyed to the conveyance destination switching unit 104 after being determined to be a normal image by the image inspection unit 103. Further, page01n on which the same image as page01 is to be formed as a recovery print of page01 is being subjected to a printing process in the printing unit 102.

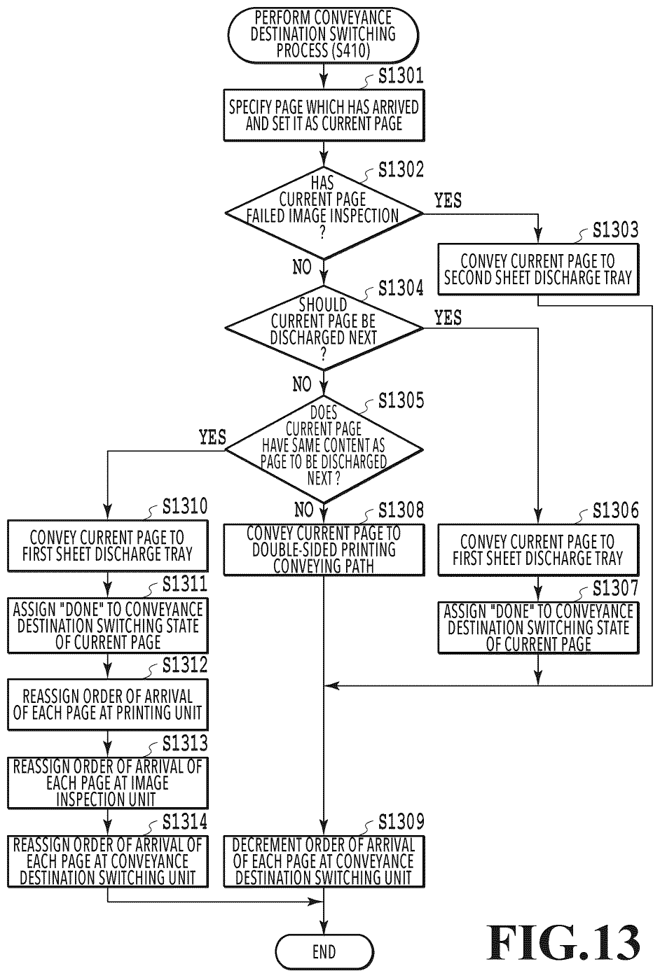

FIG. 11C shows that page02 is discharged to the first sheet discharge tray 108. Here, page02 is discharged prior to page01 which should be originally discharged to the first sheet discharge tray 108 next as a result of comparing the print contents of page01 and page02 and determining that they are the same image, which process flow will be described later with reference to FIG. 13.

FIG. 11D shows that the pages are discharged to the first sheet discharge tray 108 such that page03 is stacked on page02 and page01n, which is the recovery print of page01, is stacked on page03.

As a result of the above, the pages are discharged to the first sheet discharge tray 108 in order of page02, page03, and page01n. Although this is different from the original discharge order of page01, page02, and page03, the order of print contents is correct.

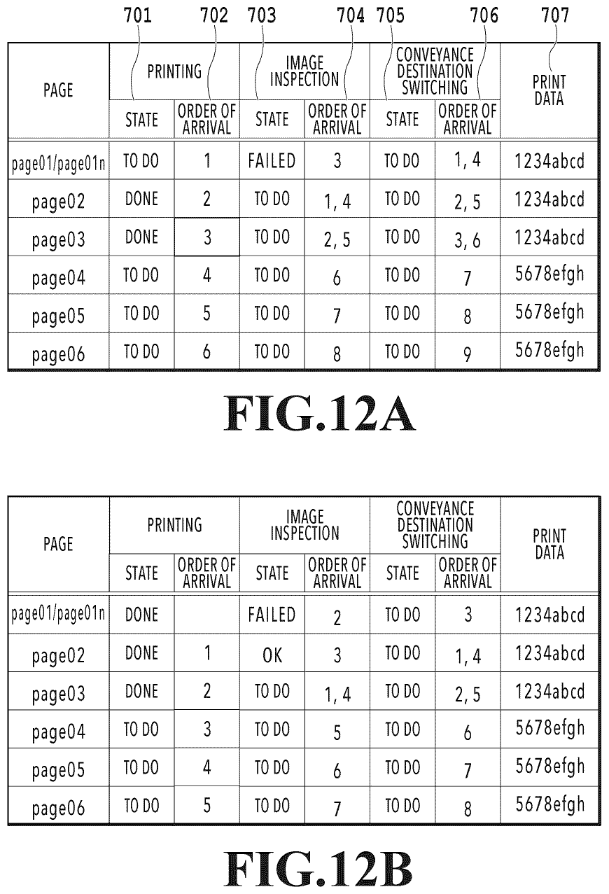

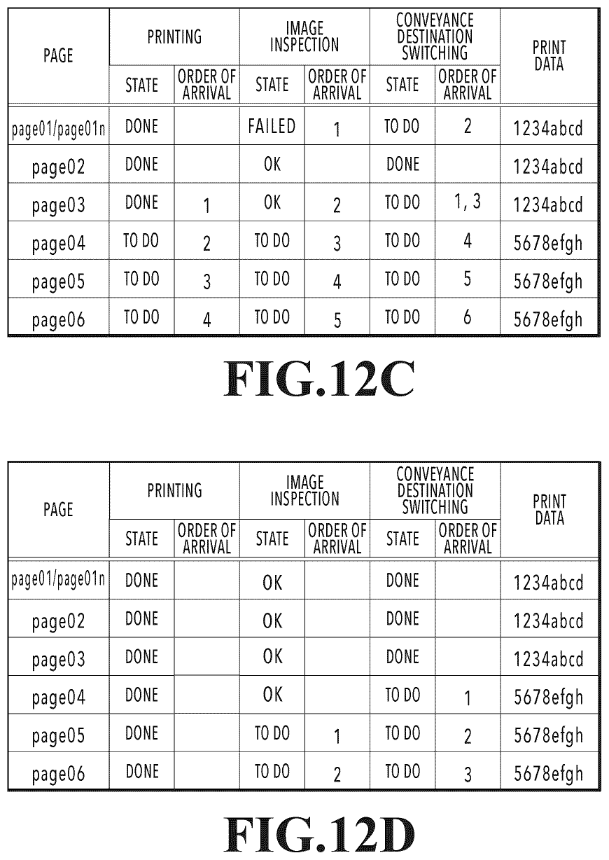

FIGS. 12A to 12D show an example of the course of updating of the page management data relating to the second embodiment. Each item in the drawings is as described above with reference to FIGS. 7A to 7G. Further, FIGS. 12A to 12D show the course of updating of the page management data in a case where a specific page is determined to be an abnormal image on the time series and correspond to the states of conveyance/output shown in FIGS. 11A to 11D, respectively.

FIG. 12A is the page management data updated in response to the determination by the image inspection control unit 304 that page01 is an abnormal image. Here, “page01” for which recovery printing is performed is changed to “page01/page01n” and the printing state 701 of the page is changed to “to do.” “1” is reallocated to page01/page01n in the order of arrival 702 at the printing unit 102 and the subsequent numbers are reallocated to page02 and the subsequent pages. In the order of arrival 704 at the image inspection unit 103, the numbers are first reallocated to page02 and page03, which are subsequent to the page determined to be an abnormal image and are prior to the reprinted page. In the order of arrival 704, the subsequent numbers are further reallocated to the respective pages sequentially from page01/page01n. In the order of arrival 706 at the conveyance destination switching unit 104, the numbers are reallocated first to page01/page01n and then to page02 and page03, which are subsequent to the page determined to be an abnormal image and are prior to the reprinted page. In the order of arrival 706, the subsequent numbers are further reallocated to the respective pages sequentially from page01/page01n.

FIG. 12B is the page management data updated in response to the determination that page02 is a normal image and the execution of a printing process for page01n as recovery printing of page01. Since the above processes are performed, the state 701 of page01 and the state 703 of page02 are updated. Page01 has been discharged to the second sheet discharge tray 109, but page01n is yet to be discharged to the first sheet discharge tray 108. Thus, the state 705 of page01/page01n remains “to do.” Further, the orders of arrival 702, 704, and 706 reassigned in FIG. 12A are each decremented.

FIG. 12C is the page management data updated in response to the discharge of page02 to the first sheet discharge tray 108 due to the sameness of print data of page02 and page01 and the determination that page03 is a normal image. Since the above processes are performed, the state 705 of page02 and the state 703 of page03 are updated. Until FIG. 12B, two numbers are allocated to page02 in the order of arrival 706 such that page02 stays once and is then discharged after page01. However, since it is determined that print data of page02 is the same as print data of page01, what are reassigned in FIG. 12A are further reassigned in FIG. 12C. More specifically, since page02 has been discharged to the first sheet discharge tray, the orders of arrival 702, 704, and 706 of page02 are blanked. In line with this, decremented numbers are reallocated to page03 and the subsequent pages in the order of arrival 704 and 706.

FIG. 12D is the page management data updated in response to the execution of the printing process up to page06, the execution of the image inspection process up to page04, and the execution of the conveyance destination switching process up to page03. Since the above processes are performed, the states 701, 703, and 705 are each updated. Further, the orders of arrival 702, 704, and 706 reassigned in FIG. 12C are each decremented.

FIG. 13 shows a flowchart for illustrating the conveyance destination switching process relating to the second embodiment. This conveyance destination switching process corresponds to S410 shown in FIG. 4. The description will be added below in line with this flowchart.

In S1301, the print job management unit 308 specifies a page which has arrived at the conveyance destination switching unit 104 and sets the page as a current page. The page which has arrived is specified by searching the page management data for a page which should arrive at the conveyance destination switching unit 104 next, that is, a page whose order of arrival is “1.”

In S1302, the print job management unit 308 determines whether the image inspection state 703 of the current page is “failed.” In a case where the image inspection state 703 is determined to be “failed,” the process advances to S1303. In a case where the image inspection state 703 is determined to be “OK,” the process advances to S1304.

In S1303, the print job management unit 308 causes the conveyance destination switching control unit 309 to discharge the current page to the second sheet discharge tray 109.

In S1304, the print job management unit 308 determines whether the current page is a page to be discharged next. This is determined according to whether a number other than “1” is stored as the order of arrival 706 of the page which has arrived at the conveyance destination switching unit 104. In a case where the current page is determined to be a page to be discharged next, the process advances to S1306. In a case where the current page is determined not to be a page to be discharged next, the process advances to S1305.

In S1305, the print job management unit 308 determines whether the current page has the same content as the page to be discharged next. This is determined by comparing print data on the current page with print data on the page to be discharged next. In the example of FIG. 12C, the page to be discharged next is page03, which has the smallest number in the order of arrival 706 at the conveyance destination switching unit 104 among the pages whose conveyance destination switching state 705 is “to do.” As a result of comparing print data on page03 with print data on page02, which is the current page, both of the pages have the print data “1234abcd.” The current page is therefore determined to have the same content as the page to be discharged next.

In S1306, the print job management unit 308 causes the conveyance destination switching control unit 309 to discharge the current page to the first sheet discharge tray 108.

In S1307, the print job management unit 308 assigns “done” to the conveyance destination switching state 705 of the current page.

In S1308, the print job management unit 308 causes the conveyance destination switching control unit 309 to convey the current page to the double-sided printing conveying path 110 without performing an inversion process.

In S1309, the print job management unit 308 decrements the order of arrival 702 of each page at the conveyance destination switching unit 104.

In S1310, the print job management unit 308 causes the conveyance destination switching control unit 309 to convey the current page to the first sheet discharge tray 108.

In S1311, the print job management unit 308 assigns “done” to the conveyance destination switching state 705 of the current page.

In S1312, the print job management unit 308 reassigns the order of arrival 702 of each page at the printing unit 102. In this reassignment of the order of arrival 702, the order of arrival 702 of the current page is blanked and the other numbers in the order of arrival 702 are decremented.

In S1313, the print job management unit 308 reassigns the order of arrival 704 of each page at the image inspection unit 103. In this reassignment of the order of arrival 704, the order of arrival 704 of the current page is blanked and the other numbers in the order of arrival 704 are decremented.

In S1314, the print job management unit 308 reassigns the order of arrival 706 of the pages whose conveyance destination switching state 705 is “to do” at the conveyance destination switching unit 104. In this reassignment of the order of arrival 706, the order of arrival 706 of the current page is blanked and the other numbers in the order of arrival 706 are decremented.

As described above, in the present embodiment, even in a case where a specific page is determined to be an abnormal image in group printing to form an image of the same content consecutively on a plurality of pages, all pages including a recovery print of the page are discharged to the first sheet discharge tray 108 so that the order of print contents is correct.

### Third Embodiment

### Measures for Double-Sided Printing

The third embodiment of the present disclosure will be described below mainly focusing on differences from the first embodiment. It should be noted that the technical scope of the present disclosure is not limited to this embodiment.

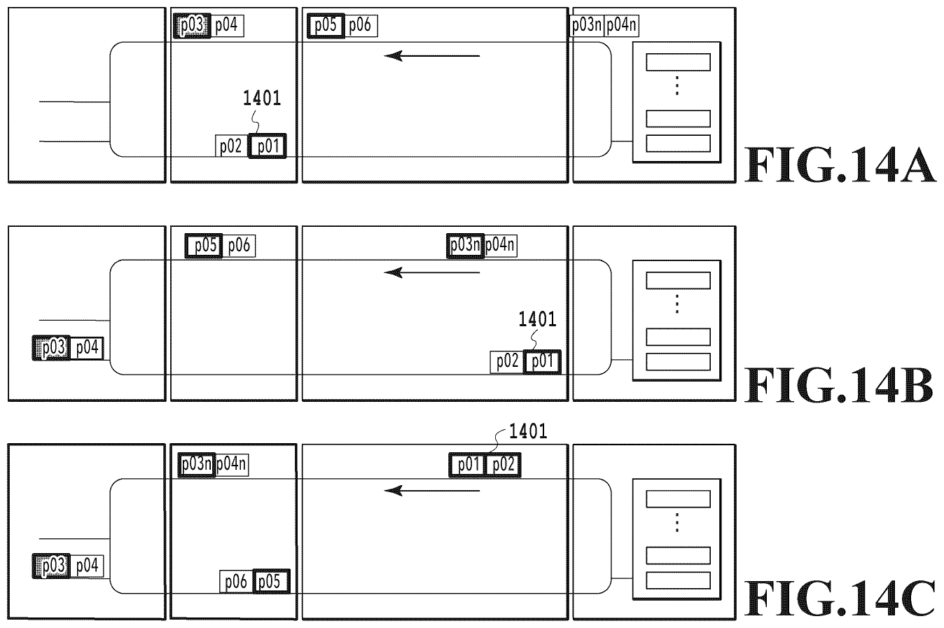

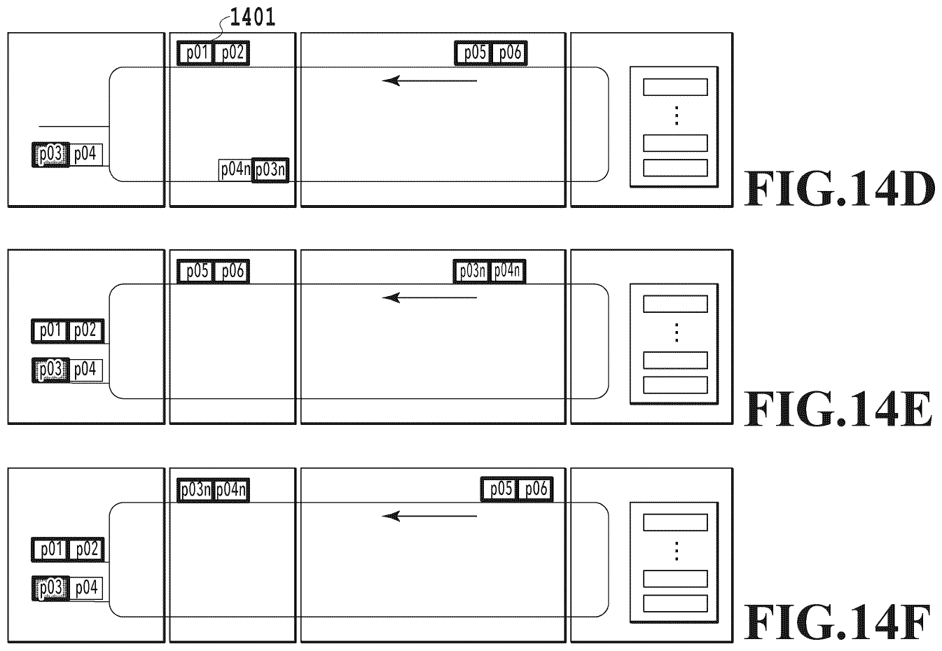

FIGS. 14A to 14G show an example of the course of printing process/image inspection process/conveyance destination switching process according to the third embodiment and show the course of conveyance/output of sheets in a case where a specific page is determined to be an abnormal image on the time series. In the drawings, p01p02, p03p04, and p05p06 indicate double-sided printing sheets; for example, p01p02 indicates that page01 is printed on the front side and page02 is printed on the back side. Here, as shown by 1401 in the drawings, in the case of performing a double-sided printing process, a sheet with its front side printed is conveyed from the conveyance destination switching unit 104 to the double-sided printing conveying path 110 and then fed to the printing unit 102 again to print the back side. In the drawings, a sheet with a colored background (p03p04) represents a page determined to be an abnormal image by the image inspection unit 103 and a page enclosed by thick lines represents a printed page.

FIG. 14A shows that p03p04 is being conveyed to the conveyance destination switching unit 104 after page03 is determined to be an abnormal image by the image inspection unit 103. p05p06 is being conveyed to the image inspection unit 103 after page05 is subjected to a printing process by the printing unit 102. p01p02 is being conveyed in the double-sided printing conveying path 110.

FIG. 14B shows that p03p04 has been discharged to the second sheet discharge tray 109 and p05p06 is being conveyed to the conveyance destination switching unit 104 after page05 is determined to be a normal image by the image inspection unit 103. Page03n of p03np04n, which is a sheet for reprinting of p03p04, is being subjected to a printing process by the printing unit 102.

FIG. 14C shows that page03/page03n, which is the front side of p03np04n, has been determined to be a normal image by the image inspection unit 103. Page02, which is the back side of p01p02, is being subjected to a printing process by the printing unit 102, and p05p06 is being conveyed in the double-sided printing conveying path 110.

FIG. 14D shows that page02 of p01p02 has been determined to be a normal image by the image inspection unit 103 and page06, which is the back side of p05p06, is being subjected to a printing process by the printing unit 102. p03np04n is being conveyed in the double-sided printing conveying path 110.

FIG. 14E shows that p01p02 has been discharged to the first sheet discharge tray 108 and page06 of p05p06 has been determined to be a normal image by the image inspection unit 103. Page04, which is the back side of p03np04n, is being subjected to a printing process by the printing unit 102.

FIG. 14F shows that page04 of p03np04n has been determined to be a normal image by the image inspection unit 103 and p05p06 is passing through the printing unit 102 from the double-sided printing conveying path 110.

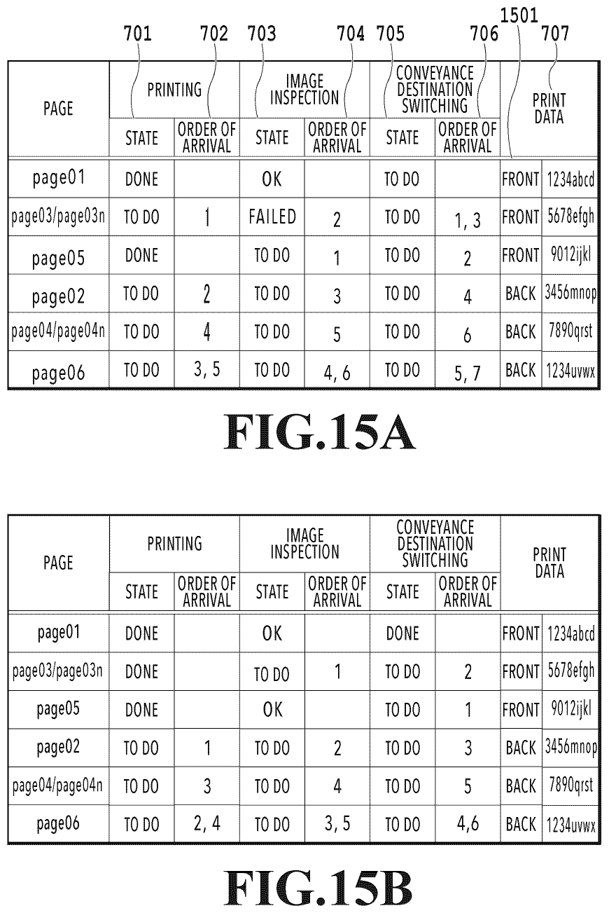

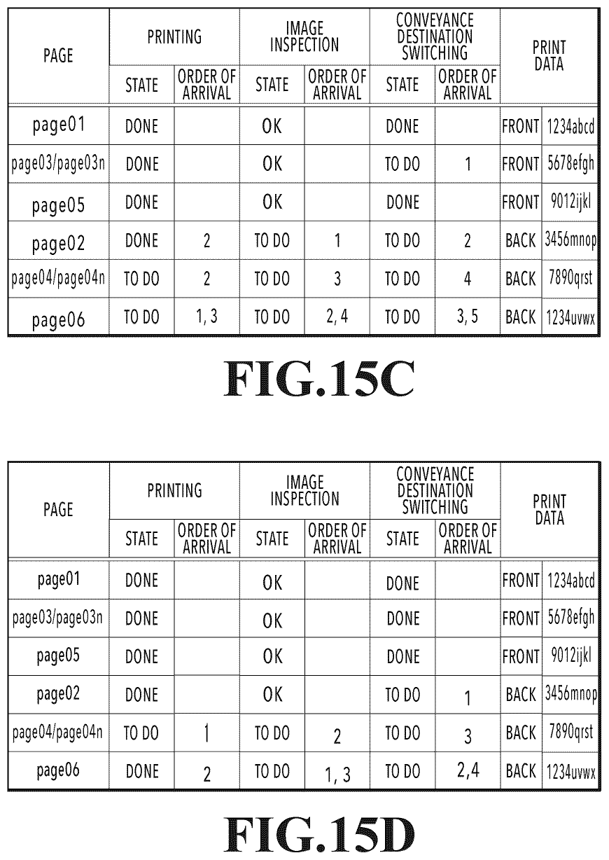

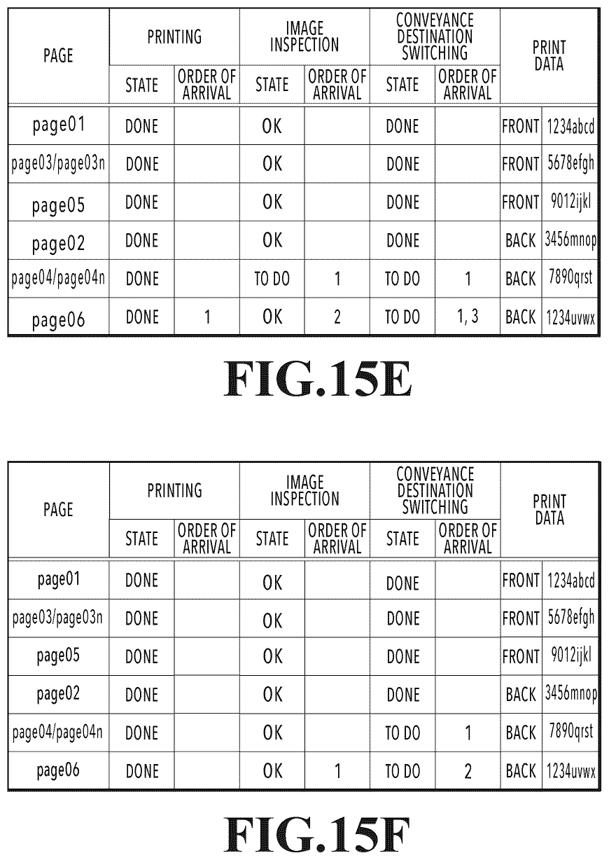

FIGS. 15A to 15F, 16, and 17 show an example of the page management data with the reassigned processing states and orders of arrival according to the third embodiment. Print data 707 has item 1501 indicating a printed side and shows whether each print data should be printed on the front side or the back side. The other items are as described above with reference to FIGS. 7A to 7G. However, in the printing order of double-sided printing in the present embodiment, a front side page (page01, page03, page05) is followed by a back side page (page02, page04, page06).

In the example of the page management data shown in FIGS. 15A to 15F, an abnormal image is detected on the front side and the processing states and orders of arrival are reassigned accordingly.

FIG. 15A is the page management data updated in response to the execution of a printing process up to page05 and the determination that page03 is an abnormal image. Here, “page03” for which recovery printing is performed is changed to “page03/page03n” and the printing state 701 of the page is changed to “to do.” Page04 is also changed to page04/page04n as page04 corresponds to the back side of page03.

Since page03/page03n is subjected to a printing process immediately after page05, “1” is reallocated to the order of arrival 702 of the page at the printing unit 102 and the subsequent numbers are reallocated to the pages subsequent to page05. In the order of arrival 704 at the image inspection unit 103, the number is first reallocated to page05, which is subsequent to the page determined to be an abnormal image and is prior to the reprinted page. In the order of arrival 704, the subsequent numbers are further reallocated to the respective pages sequentially from page03/page03n. In the order of arrival 706 at the conveyance destination switching unit 104, the numbers are allocated first to page03/page03n and then to page05, which is subsequent to the page determined to be an abnormal image and is prior to the reprinted page. In the order of arrival 706, the subsequent numbers are further reallocated to the respective pages sequentially from page03/page03n.

FIGS. 15B to 15F are the page management data updated in response to updating of each of the states 701, 703, and 704 in execution of each process. Further, the orders of arrival 702, 704, and 706 reassigned in FIG. 15A are each decremented.

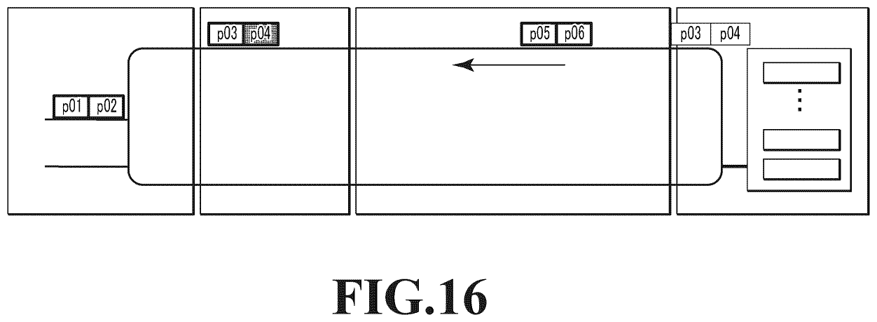

FIG. 16 shows that an abnormal image has been detected on page04, which is the back side page. In this case, reprinting is also performed for page03, which is the front side page printed on the same sheet as page04. Thus, p05p06, which is subsequent to the sheet including the page on which an abnormal image is detected and is prior to the sheet including the reprinted page, makes two stays. That is, the number of stays corresponds to the number of reprinted pages.

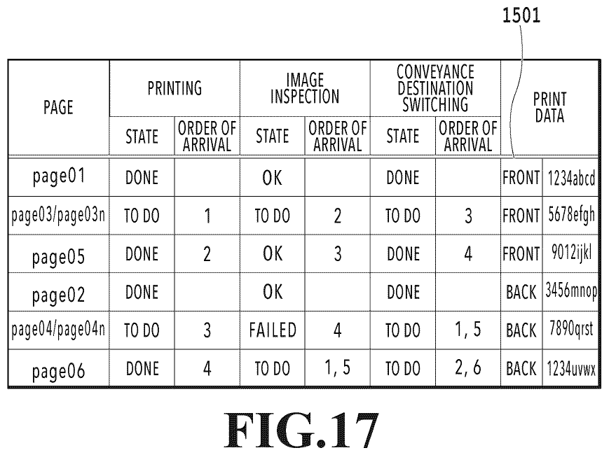

FIG. 17 is the page management data updated in response to the detection of an abnormal image on page04, which is the back side page. Here, page03 and page04 are changed to page03/page03n and page04/page04n to perform recovery printing. Since the image inspection unit 103 determines that page04 is an abnormal image, the printing state 701 of each of page03/page03n and page04/page04n is changed to “to do.” Further, “1” is reassigned to the order of arrival 702 at the printing unit 102 and the subsequent numbers are reallocated to page05 and the subsequent pages. In the order of arrival 704 at the image inspection unit 103, the number is first reallocated to page06, which is subsequent to the page determined to be an abnormal image and prior to the reprinted page. In the order of arrival 704, the subsequent numbers are further reallocated to the respective pages sequentially from page03/page03n. In the order of arrival 706 at the conveyance destination switching unit 104, the numbers are reallocated first to page04/page04n and then to page06, which is subsequent to the page determined to be an abnormal image and prior to the reprinted page. In the order of arrival 706, the subsequent numbers are further reallocated to the respective pages sequentially from page03/page03n.

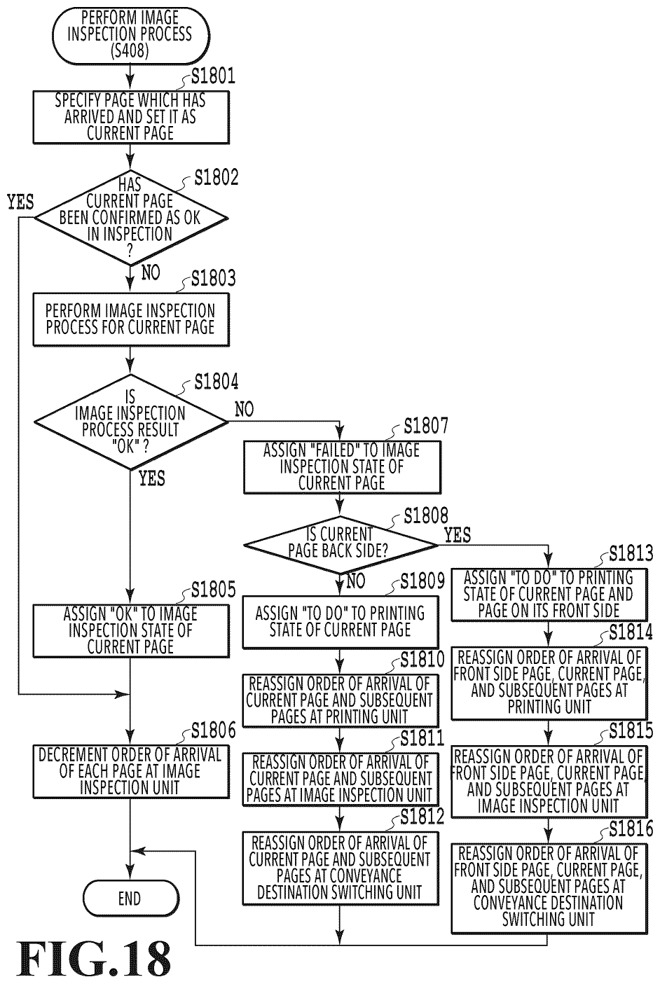

FIG. 18 shows a flowchart for illustrating the image inspection process according to the third embodiment.

Since S1801 to S1807 and S1809 are the same process as S901 to S908, the description of these steps is omitted here and the process from S1808 onward is described.

In S1808, the print job management unit 308 determines whether the current page is the back side. In a case where the current page is determined to be the back side, the process advances to S1813. In a case where the current page is determined to be the front side, the process advances to S1809.

In S1810, the print job management unit 308 reassigns the order of arrival 702 of the current page and the subsequent pages at the printing unit 102 in the page management data. In this reassignment, “1” is allocated to the reprinted page and the subsequent numbers are allocated to the subsequent pages.

In S1811, the print job management unit 308 reassigns the order of arrival 704 of the current page and the subsequent pages at the image inspection unit 103 in the page management data. In this reassignment, the numbers are first allocated to pages which are subsequent to the page determined to be an abnormal image and are prior to the reprinted page and the subsequent numbers are then allocated to the respective pages sequentially from the reprinted page.

In S1812, the print job management unit 308 reassigns the order of arrival 706 of the current page and the subsequent pages at the conveyance destination switching unit 104. In this reassignment, the numbers are allocated first to the reprinted page and then to the pages which are subsequent to the page determined to be an abnormal image and are prior to the reprinted page. The subsequent numbers are allocated the respective pages sequentially from the reprinted page.

In S1813, the print job management unit 308 returns the printing state 701 of the current page and the front side page printed on the same sheet as the current page to “to do” in the page management data.

In S1814, the print job management unit 308 reassigns the order of arrival 702 of the front side page printed on the same sheet as the current page and the subsequent pages at the printing unit 102 in the page management data. In this reassignment, “1” is allocated to the reprinted front side page and the subsequent numbers are allocated to the subsequent pages.

In S1815, the print job management unit 308 reassigns the order of arrival 704 of the front side page printed on the same sheet as the current page and the subsequent pages at the image inspection unit 103 in the page management data. In this reassignment, the numbers are first allocated to the pages which are subsequent to the page determined to be an abnormal image and are prior to the reprinted page and the subsequent numbers are then allocated to the respective pages sequentially from the reprinted front side page.

In S1816, the print job management unit 308 reassigns the order of arrival 706 of the front side page printed on the same sheet as the current page and the subsequent pages at the conveyance destination switching unit 104. In this reassignment, the numbers are allocated first to the reprinted current page and then to the pages which are subsequent to the page determined to be an abnormal image and are prior to the reprinted page, and the subsequent numbers are allocated to the respective pages sequentially from the reprinted front side page.

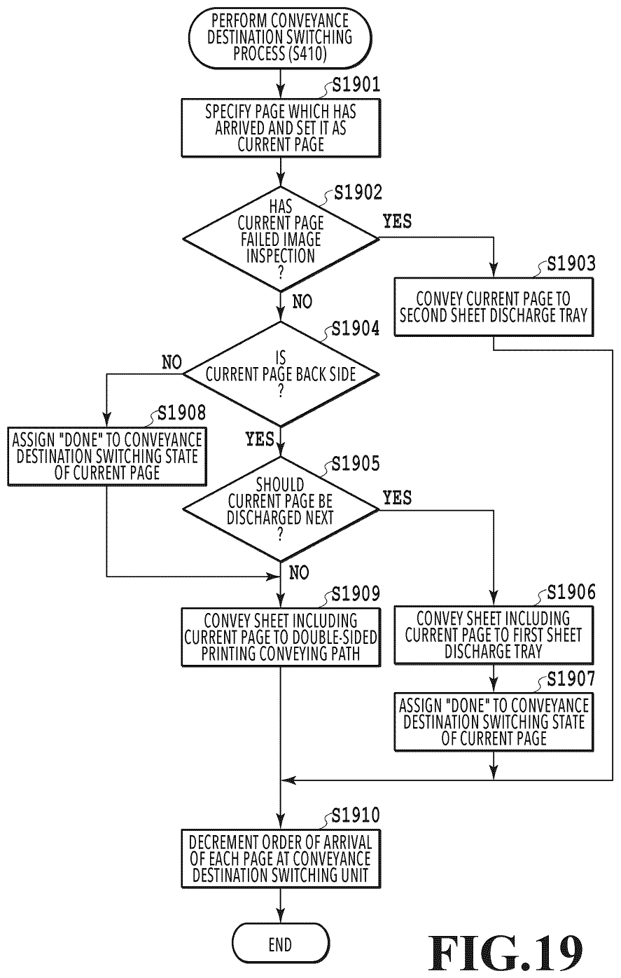

FIG. 19 shows a flowchart for illustrating the conveyance destination switching process according to the third embodiment. This conveyance destination switching process corresponds to S410 shown in FIG. 4.

In S1901, the print job management unit 308 specifies a page which has arrived and sets the page as a current page. The page which has arrived is specified by searching the page management data for a page which should arrive at the conveyance destination switching unit 104 next, that is, a page whose order of arrival 706 at the conveyance destination switching unit 104 is “1.”

In S1902, the print job management unit 308 determines whether the image inspection state of the current page is “failed.” In a case where the image inspection state 703 is determined to be “failed,” the process advances to S1903. In a case where the image inspection state 703 is determined to be “OK,” the process advances to S1904.

In S1903, the print job management unit 308 causes the conveyance destination switching control unit 309 to discharge the current page to the second sheet discharge tray 109.

In S1904, the print job management unit 308 determines whether the current page is the back side. In a case where the current page is determined to be the back side, the process advances to S1905. In a case where the current page is determined to be the front side, the process advances to S1908.

In S1905, the print job management unit 308 determines whether the current page is a page to be discharged next. This is determined according to whether only “1” is assigned to the page which has arrived in the order of arrival 706 at the conveyance destination switching unit 104. In a case where the current page is determined to be a page to be discharged next, the process advances to S1906. In a case where the current page is determined not to be a page to be discharged next, the process advances to S1909.

In S1906, the print job management unit 308 causes the conveyance destination switching control unit 309 to discharge the current page to the first sheet discharge tray 108. The sheet which arrives at S1906 is a page which has front and back sides both determined to be normal images in the image inspection process and is to be discharged next.

In S1907, the print job management unit 308 assigns “done” to the conveyance destination switching state of the current page.

In S1908, the print job management unit 308 assigns “done” to the conveyance destination switching state of the current page.

In S1909, the print job management unit 308 causes the conveyance destination switching control unit 309 to convey the current page to the double-sided printing conveying path 110 without performing an inversion process.

In S1809, the print job management unit 308 decrements the order of arrival of each page at the conveyance destination switching unit 104.

As described above, in the present embodiment, even in a case where a specific page of consecutive pages is determined to be an abnormal image in double-sided printing, all pages including a recovery print of the page are discharged in page order to the first sheet discharge tray 108.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, in a printing device capable of double-sided printing, even in a case where a specific page is reprinted during printing of a plurality of consecutive pages, print products can be output in correct page order without the need to add a conveying path.

This application claims the benefit of Japanese Patent Application No. 2024-110924, filed Jul. 10, 2024, which is hereby incorporated by reference herein in its entirety.

What is claimed is:

1. A printing device with a conveying path for performing a printing process for both sides of a sheet, the printing device comprising:
a printing unit configured to perform a printing process for the sheet according to a print job;
an inspection unit configured to perform an inspection process for a printed sheet subjected to the printing process; and
a conveyance unit configured to discharge a printed sheet not detected being abnormal in an inspection result by the inspection unit to a first discharge destination and discharge a printed sheet detected being abnormal in the inspection result to a second discharge destination different from the first discharge destination,
wherein in a case where the printing unit performs a reprinting process for a printed sheet detected being abnormal in the inspection result during a printing process for a plurality of consecutive pages, the conveyance unit conveys, to the conveying path, a printed sheet not detected being abnormal which is subsequent to the printed sheet detected being abnormal and is prior to the printed sheet subjected to the reprinting process such that the printed sheet makes a stay in the conveying path, and discharges the printed sheet subjected to the reprinting process to the first discharge destination prior to the staying printed sheet.

2. The printing device according to claim 1, wherein
the conveyance unit discharges, to the first discharge destination, the printed sheet subjected to a printing process based on same image data as the printed sheet detected being abnormal among printed sheets not detected being abnormal which are subsequent to the printed sheet detected being abnormal and are prior to the printed sheet subjected to the reprinting process, without causing the printed sheet to make a stay in the conveying path.

3. The printing device according to claim 1, wherein
the conveyance unit makes the stay a number of times corresponding to a number of pages subjected to the reprinting process.

4. The printing device according to claim 1, wherein
a printed sheet not detected being abnormal which is conveyed to the conveying path for the stay is subjected to neither a printing process by the printing unit nor an inspection process by the inspection unit.

5. The printing device according to claim 1, wherein
the conveyance unit does not invert the printed sheet in a case where the stay is made.

6. The printing device according to claim 1, wherein
the inspection unit obtains a read image of the printed sheet and performs an inspection based on a result of comparison between the read image and a corresponding reference image.

7. The printing device according to claim 1, wherein
the conveyance unit selects a conveyance destination of the printed sheet based on management information including a processing state in each of the printing unit, the inspection unit, and the conveyance unit and order of arrival at each of the printing unit, the inspection unit, and the conveyance unit of each page designated in the print job.

8. The printing device according to claim 7, wherein
the management information is updated each time the sheet and the printed sheet arrive at any one of the printing unit, the inspection unit, and the conveyance unit.

9. A control method of a printing device with a conveying path for performing a printing process for both sides of a sheet, the control method comprising:
performing a printing process for the sheet according to a print job;
performing an inspection process for a printed sheet subjected to the printing process;
discharging a printed sheet not detected being abnormal in an inspection result by the performing the inspection process to a first discharge destination and discharging a printed sheet detected being abnormal in the inspection result to a second discharge destination different from the first discharge destination; and
in a case where a reprinting process is performed for a printed sheet detected being abnormal in the inspection result during a printing process for a plurality of consecutive pages in the performing the printing process, conveying, to the conveying path, a printed sheet not detected being abnormal which is subsequent to the printed sheet detected being abnormal and is prior to the printed sheet subjected to the reprinting process such that the printed sheet makes a stay in the conveying path, and discharging the printed sheet subjected to the reprinting process to the first discharge destination prior to the staying printed sheet.

10. A non-transitory computer-readable storage medium storing a program for causing a computer to perform a control method of a printing device with a conveying path for performing a printing process for both sides of a sheet, the control method comprising:
performing a printing process for the sheet according to a print job;
performing an inspection process for a printed sheet subjected to the printing process;
discharging a printed sheet not detected being abnormal in an inspection result by the performing the inspection process to a first discharge destination and discharging a printed sheet detected being abnormal in the inspection result to a second discharge destination different from the first discharge destination; and
in a case where a reprinting process is performed for a printed sheet detected being abnormal in the inspection result during a printing process for a plurality of consecutive pages in the performing the printing process, conveying, to the conveying path, a printed sheet not detected being abnormal which is subsequent to the printed sheet detected being abnormal and is prior to the printed sheet subjected to the reprinting process such that the printed sheet makes a stay in the conveying path, and discharging the printed sheet subjected to the reprinting process to the first discharge destination prior to the staying printed sheet.
